(19) United States
(12) Patent Application Publication
(10) Pub. No.: US 2014/0212997 A1
(43) Pub. Date: Jul. 31, 2014

(54) PROCESS FOR PRODUCING SUBSTRATE FOR LIQUID EJECTION HEAD AND PROCESS FOR PROCESSING SILICON SUBSTRATE

(71) Applicant: CANON KABUSHIKI KAISHA, Tokyo (JP)

(72) Inventors: Seiichiro Yaginuma, Tokyo (JP); Hiroyuki Shimoyama, Kawasaki-shi (JP); Masaki Ohsumi, Yokosuka-shi (JP); Taichi Yonemoto, Isehara-shi (JP); Shuji Koyama, Kawasaki-shi (JP)

(73) Assignee: CANON KABUSHIKI KAISHA, Tokyo (JP)

(21) Appl. No.: 14/150,181

(22) Filed: Jan. 8, 2014

(30) Foreign Application Priority Data
Jan. 28, 2013 (JP) 2013-013072

(51) Int. Cl. B41J 2/16

(52) U.S. Cl. CPC B41J 2/1629; B41J 2/1634
USPC 438/21

(57) ABSTRACT

A process for producing a substrate for a liquid ejection head in which a depressed portion is formed on a second surface that is a surface opposite to a first surface of a silicon substrate having an element formation region on the first surface with a peripheral side region left, the process including the steps of (1) forming an etching mask layer covering the second surface of the silicon substrate; (2) subjecting the etching mask layer and the silicon substrate to laser abrasion processing to form a pattern opening that does not pass through the silicon substrate; and (3) performing a wet etching process to the silicon substrate where the pattern opening is formed from a side of the second surface to form the depressed portion. The depressed portion is formed over a center side region including a position corresponding to the element formation region.

### BACKGROUND OF THE INVENTION

1. Field of the Invention

The present invention relates to a process for producing a substrate for a liquid ejection head. The present invention also relates to a process for processing a silicon substrate.

2. Description of the Related Art

Japanese Patent Application Laid-Open No. 2011-83787 discloses a process for locally thinning a substrate. In this process, a laser beam transparent with respect to a substrate material is condensed into a substrate to form an altered part. It is described that an infrared laser beam can be used for a silicon substrate. In a laser-altered region, the etching rate is larger than that in a non-alteration region. The altered part is removed by wet etching to form a depressed portion, thereby allowing the substrate to be locally thinned.

### SUMMARY OF THE INVENTION

The present invention is a process for producing a substrate for a liquid ejection head, a depressed portion is formed on a second surface that is a surface opposite to a first surface of a silicon substrate having an element formation region on the first surface with a peripheral side region left, the process including the steps of (1) forming an etching mask layer covering the second surface of the silicon substrate; (2) subjecting the etching mask layer and the silicon substrate to laser abrasion processing to form a pattern opening that does not pass through the silicon substrate; and (3) performing a wet etching process to the silicon substrate where the pattern opening is formed from a side of the second surface, to form the depressed portion wherein the depressed portion is formed over a center side region including a position corresponding to the element formation region.

Furthermore, the present invention is a process for processing a silicon substrate, a depressed portion is formed on a surface of a silicon substrate with a peripheral side region left, the process including the steps of (1) forming an etching mask layer covering the surface; (2) subjecting the etching mask layer and the silicon substrate to laser abrasion processing to form a pattern opening that does not pass through the silicon substrate; and (3) performing a wet etching process to the silicon substrate where the pattern opening is formed from the surface to form the depressed portion, wherein the depressed portion is formed over a center side region.

Further features of the present invention will become apparent from the following description of exemplary embodiments with reference to the attached drawings.

### BRIEF DESCRIPTION OF THE DRAWINGS

FIG. 1 is a schematic plan view illustrating a configuration of a substrate for a liquid ejection head that is produced by a producing process of the embodiment.

FIGS. 2A, 2B, 2C and 2D are schematic sectional process diagrams for illustrating a process for producing a substrate for a liquid ejection head of the embodiment.

FIG. 3 is a schematic plan view for illustrating a process for forming a pattern opening by laser abrasion processing of the embodiment.

FIGS. 4A and 4B are schematic plan views for illustrating an etching mask leaving portion arranged in a peripheral side region of the substrate of the embodiment.

FIGS. 5A, 5B and 5C are schematic sectional process diagram for illustrating a process for producing a substrate for a liquid ejection head of the embodiment.

### DESCRIPTION OF THE EMBODIMENTS

Preferred embodiments of the present invention will now be described in detail in accordance with the accompanying drawings.

According to the study by the inventors of the present invention, in the processing process in Japanese Patent Application Laid-Open No. 2011-83787, it is sometimes difficult to process a surface having projections and depressions which scatter laser light. A processing process with a high processing flexibility is required. Furthermore, there is a possibility that, when a material different in coefficient of thermal expansion from a substrate material is formed on a surface opposite to a surface to be thinned, stresses are applied to the substrate and warpage occurs in the substrate.

The present invention has thus an object to provide a process for producing a substrate for a liquid ejection head that can easily process a substrate having a surface with projections and depressions, reduce occurrence of warpage of the substrate, and locally thin the substrate.

An embodiment of the present invention relates to a process for producing a substrate for a liquid ejection head in which a depressed portion is formed on a second surface that is a surface opposite to a first surface of a silicon substrate having an element formation region on the first surface with a peripheral side region left.

An embodiment of the present invention is hereinafter described in detail.

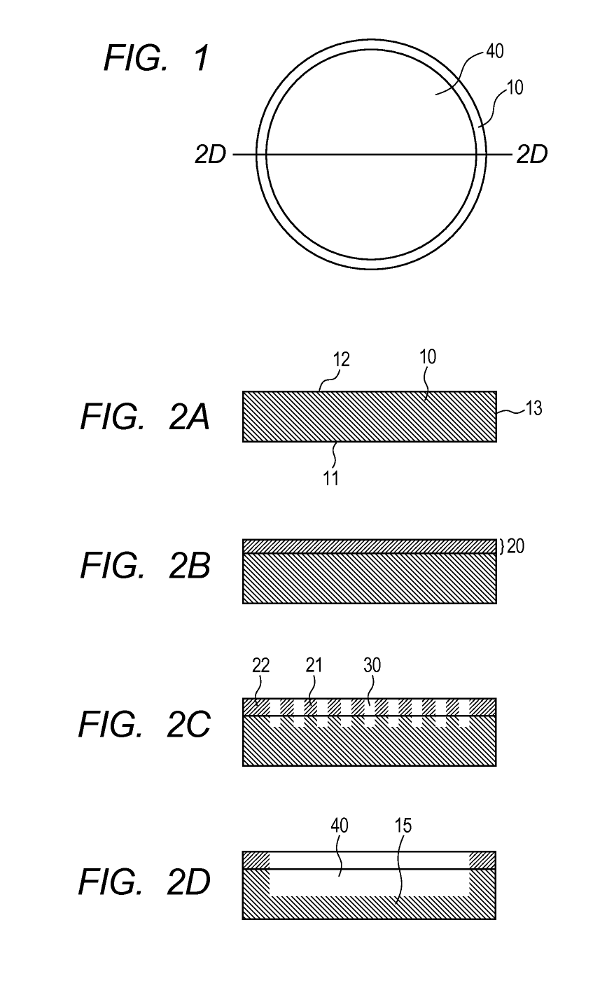

FIG. 1 is a schematic plan view illustrating an example of a configuration of a substrate for a liquid ejection head that is produced by a producing process of this embodiment. In FIG. 1, a depressed portion 40 is formed on a back surface (second surface) of a silicon substrate 10. The depressed portion 40 is formed over a center side region including a position corresponding to the element formation region (not illustrated in FIG. 1). The depressed portion 40 is formed over the center side region, thereby allowing the silicon substrate to be substantially thinned.

FIGS. 2A to 2D are sectional process diagrams for illustrating a process for producing a substrate for a liquid ejection head of this embodiment. A section taken along line 2D-2D of FIG. 1 is illustrated for each process.

First, as illustrated in FIG. 2A, the silicon substrate 10 having a first surface 11 and a second surface 12, which is opposite to the first surface, is prepared. The first surface 11 of the silicon substrate has an element formation region (not illustrated).

In the element formation region, multiple ejection-energy-generating elements for generating energy for ejecting liquid, and wiring and terminals for driving the ejection-energy-generating elements are formed.

The silicon substrate is, for instance, a silicon wafer, on which multiple ejection element substrates are formed using a substrate for a liquid ejection head acquired by the producing process of this embodiment. In the element formation region, the multiple ejection-energy-generating elements and wiring therefor are formed such that the multiple ejection element substrates can be formed.

The thickness of the silicon substrate is, for instance, 100 to 3000 μm. The thickness can be 500 to 1000 μm in consideration of facilitation of handing as well as large number of products and high supply stability.

Next, as illustrated in FIG. 2B, an etching mask layer 20 that is etching-resistant to etchants for a wet etching process in a later step is formed on the second surface 12.

The etching mask layer can be formed as one layer or two layers or more.

The thickness of the etching mask layer is, for instance, 0.1 to 10 μm. The thickness can be 0.5 to 5 μm that facilitates formation by deposition or coating in consideration of time required to form a mask and etching resistance.

If an ejection-energy-generating element has already been formed on the silicon substrate, the layer formed in a step of forming the element may serve as an etching mask layer 20. This procedure exerts an advantageous effect of reducing the number of steps. A material having low etching-resistivity may be formed on the etching mask layer 20. The etching mask layer 20 may be formed not only on the second surface 12 but also on the first surface 11 or a side surface 13.

Next, as illustrated in FIG. 2C, laser abrasion processing is performed to the etching mask layer 20 and the silicon substrate 10 to form a pattern opening 30 that does not pass through the silicon substrate.

The pattern opening 30 is formed so as to pass through the etching mask layer 20 but not to pass through the silicon substrate 10. The laser may be any types of laser that can perform abrasion processing to the substrate.

The pattern opening is arranged in a center side region where the depressed portion is to be formed but is not arranged in a peripheral side region of the second surface. The shape of the pattern opening is not specifically limited thereto so far as the depressed portion is arranged so as to be formed over the center side region including a position corresponding to the element formation region with the peripheral side region of the second surface left. FIG. 2C illustrates an etching mask leaving portion 22 that is a mask portion arranged in the peripheral side region of the second surface to be left in the wet etching process in the following step. An etching mask removing portion 21 is a mask portion that is arranged in the center side region of the second surface to be removed in the wet etching process in the later step.

The depth of the pattern opening is, for instance, to 650 μm. This depth can be 10 to 500 μm in consideration of deficiencies due to reduction in time of laser processing or laser-depth variation.

Next, as illustrated in FIG. 2D, the wet etching process is performed to the silicon substrate 10, where the pattern opening is formed, from the second surface side to form the depressed portion 40.

The depressed portion is formed over the center side region including the position corresponding to the element formation region with the peripheral side region of the second surface left.

Thus, the center side region including the position corresponding to the element formation region is etched and thinned. However, the peripheral side region is not etched and left as it is. Since the peripheral side region is thus left to have the thickness as it is, the stiffness of the substrate can be maintained, and occurrence of warpage of the substrate can be suppressed.

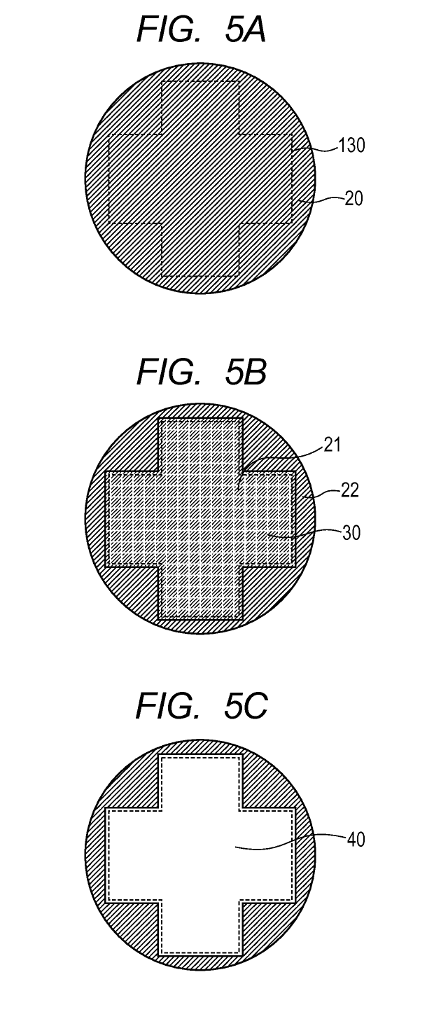

Referring to FIG. 2D, in the wet etching process, the etching mask removing portion 21 on the center side of the substrate is removed by lift-off, and the etching mask leaving portion 22 at a peripheral side of the substrate is left. Here, the etching mask leaving portion 22 is arranged along the periphery of the second surface so as not to include the position corresponding to the element formation region, as will be illustrated in FIG. 5C. This arrangement can leave the thickness of the peripheral portion of the substrate as it is. As a result, the substrate stiffness can be maintained, and warpage of the substrate can be leveled.

Time for wet etching process can be appropriately selected in consideration of the substrate thickness after thinning. In the wet etching process, etching is stopped at an etching end surface 15 to form the depressed portion 40. The etchant may be any liquid that can secure an etching selection ratio between the etching mask and the substrate. The wet etching process can be silicon crystal anisotropic etching.

For instance, if the wafer thickness is assumed to be 800 μm, the depth of the depressed portion is 30 to 700 μm. The depth can be 200 to 600 μm which exerts an effect of thinning the substrate and which provides a relatively high stiffness of the depressed portion of the substrate and a small limitation to the process conditions in steps after the thinning processing. That is to say, the thickness which is left at the depressed portion and is the difference between the wafer thickness and the depth of the depressed portion can be 100 to 600 μm.

The substrate is processed according to the procedures described in the foregoing embodiment.

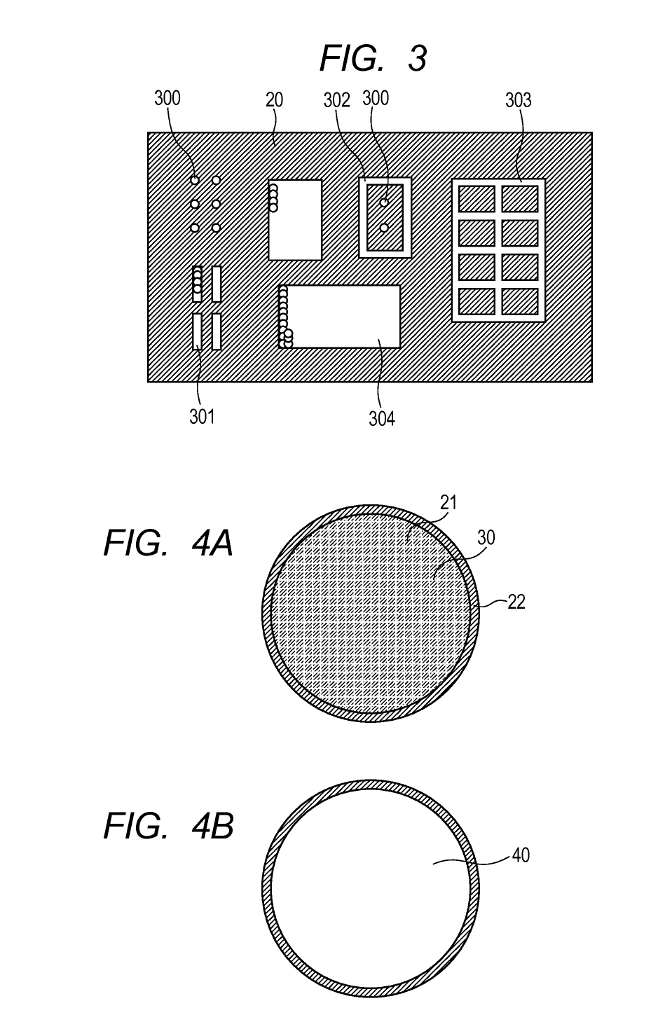

As described above, the shape of the pattern opening that does not pass through the silicon substrate is not specifically limited so far as the depressed portion is formed over the center side region including the position corresponding to the element formation region with the peripheral side region of the second surface left. As illustrated in FIG. 3, the pattern opening may be a non through hole 300 having a circular or elliptical opening, for instance. The pattern opening may be formed using any of a groove shape 301 in which the non through holes 300 communicate with each other, a frame shape 302, a lattice shape 303 and a pattern combined these shapes. The pattern opening may be formed by combining openings having a curved or polygonal shape. The pattern opening may be a single opening pattern 304 that does not have the etching mask removing portion described above and is formed by entire-surface processing. The finer the pitch of the lattice shape is, the easier lift-off can be performed. However, a fine pitch increases time for processing. Accordingly, the length of a short side of a rectangle forming a lattice can range from 200 to 1000 μm. Furthermore, the length can be range from 400 to 800 μm.

For instance, as illustrated in FIG. 4A, the lattice-shaped pattern opening 30 can be formed. That is to says, the etching mask layer is processed such that the etching mask leaving portion 22 is arranged along the periphery of the substrate, and the lattice-shaped pattern opening is arranged in the center side region. If the lattice-shaped pattern opening is formed, the etching mask leaving portion 22 is formed of multiple rectangles. The wet etching process is performed to thereby lift off the etching mask removing portion 21 arranged in the center side of the substrate but leave the etching mask leaving portion 22 arranged on the peripheral side of the substrate. As illustrated in FIG. 4B, the peripheral side region of the substrate has not been etched and is left, the depressed portion 40 is formed in the center side region.

### Example

Hereinafter, referring to FIGS. 2A to 2D, the producing process of this embodiment is described further in detail.

As illustrated in FIG. 2A, the silicon substrate 10 having a plane direction <100> is prepared. A silicon wafer having a thickness of 725 μm is used as the silicon substrate 10.

The silicon substrate 10 may have any of plane directions of a <100> plane, <110> plane and <111> plane. The <100> plane is favorable because this plane provides satisfactory semiconductor element characteristics. Defects on the second surface 12 can be suppressed by any of sandblasted processing and thermal treatment.

Next, as illustrated in FIG. 2B, a thermally-oxidized film (SiO₂) having a thickness of 1 μm is formed as the etching mask layer 20 on the second surface 12.

This formation can be performed in the step of forming the ejection-energy-generating element on the first surface 11 at the same time as the ejection-energy-generating element is formed (not illustrated).

The material of the etching mask layer 20 may be, for instance, any of inorganic materials, such as SiO, SiN, SiON, SiC and SiCN, including Si, metal materials, such as Mo, Au, Pt, Ti, Ta and W, and organic materials, such as polyimide, polyamide and cyclized rubber. Among these materials, in terms of adherence to the silicon substrate 10, inorganic materials including Si are favorable. Furthermore, the etching mask layer can be formed of at least one material selected from the group consisting of SiO, SiN, SiON, SiC and SiCN. For instance, the etching mask layer 20 may be formed by any of publicly-known methods, such as sputtering, CVD and spin coating.

This embodiment may include a step of forming a liquid ejection element on the ejection-energy-generating element formed on the first surface side. FIG. 5A is a schematic plan view of a substrate viewed from the second surface side on which the etching mask layer 20 is formed. In FIG. 5A, a broken line 130 indicates a position corresponding to the element formation region on the first surface side. As illustrated in FIG. 5B, by laser abrasion processing the pattern opening 30 is arranged at the position corresponding to the element formation region 130, thereby finally allowing the amount of the leaving portion of the substrate periphery to be increased and enabling the stiffness to be adjusted. Accordingly, advantageous effects of leveling and reducing the warpage can be exerted. Since the amount of the leaving portion of the substrate periphery is large, an advantageous effect of facilitating handing can be exerted. An alignment pattern may be formed on the leaving portion of the substrate periphery. An advantageous effect of facilitating alignment in a process after formation of the depressed portion can also be exerted.

Next, as illustrated in FIGS. 2C and 5B, the pattern opening 30 is formed according to the element formation region 130 using a third order harmonic of Nd:YVO₄ pulse laser (wavelength: 0.355 μm).

The pattern opening can be formed so as to connect non through holes. In this case, the depth of each non through hole varies to a certain extent. Accordingly, it is favorable to conduct processing so that the minimum value of the depth of the non through hole is 10 μm or more. In contrast to the case of condensing laser in the inside of the substrate to form an alteration layer, the laser abrasion can form the opening even if the second surface includes that which scatters laser light, such as a surface with projections and depressions, or that which reflects laser light, such as a metal film. The laser abrasion can use laser having a wavelength that is easily absorbed by the substrate material. Accordingly, the degree of freedom in selecting laser is high. Furthermore, there is no need to move the laser condensing position in the substrate. The shape and depth of the pattern opening can be appropriately designed in consideration of the laser power, laser processing time, etching time, and etching thickness. The etching time can be reduced by configuring the depth of the pattern opening to have at least one target value. Furthermore, the portion caused to pass through the substrate in etching (passing through portion) is deeply processed with laser, and the portion caused not to pass through the substrate in etching (non-passing-through portion) is shallowly processed. Thus, presence or absence of penetration after etching can be controlled for formation. Accordingly, a supply port that is a passing through portion can be formed at the same time as thinning conducted by forming the non penetration portion. Thus, an advantageous effect of reducing the number of steps is exerted. Laser processing that is performed to a portion caused to passes through the substrate by etching may result in passing-through of the substrate.

The laser abrasion processing can be performed in any of water, reactive gas, and vacuum. The laser may be any of solid-state lasers, such as YAG laser, YVO₄ laser, YLF laser, titanium-sapphire laser, and gas lasers, such as excimer laser and CO₂ laser. In view of high light absorbability and processing controllability, the laser wavelength can be a wavelength shorter than a wavelength around the absorption edge (wavelength: 1.1 μm) of Si that is the substrate material. Accordingly, for instance, in the case of Nd:YVO₄ laser, any of higher harmonics, such as second order harmonic (0.532 μm), third order harmonic (0.355 μm), and four order harmonic (0.266 μm), instead of the fundamental wave (1.064 μm), or excimer laser (KrF: 0.248 μm, ArF: 0.193 μm) is favorable.

Next, as illustrated in FIG. 2D, the substrate is soaked in a TMAH aqueous solution (20% by mass) at a liquid temperature of 80° C. for 400 minutes to perform a wet etching process.

The etching rate of the silicon substrate having the <100> plane is 0.5 μm/min. The etchant is circulated. The lifted-off etching mask removing portion is removed by a filter.

The etchant may be, for instance, any of basic aqueous solutions, and acidic aqueous solutions. The basic aqueous solution may be, for instance, an aqueous solution containing at least one material selected from the group consisting of tetramethylammonium hydroxide (TMAH), potassium hydroxide, sodium hydroxide, cesium hydroxide, and lithium hydroxide. The acidic aqueous solution may be, for instance, a liquid mixture of hydrofluoric acid and nitric acid. In terms of controllability of the etching shape, the etching can be Si crystal anisotropic etching using a basic aqueous solution. If any of the first surface and the side surface of the substrate is in contact with an etchant according to the specifications of an etching device, a protection layer (not illustrated) for preventing liquid from being in contact may be formed. The protection layer may be any of films having etching resistance.

As illustrated in FIG. 2D and FIG. 5C, the depressed portion 40 is formed over the center side region including the position corresponding to the element formation region 130, leaving the etching mask leaving portion 22.

A liquid ejection head can be formed using the substrate for the liquid ejection head produced according to this embodiment. In this case, publicly-known techniques can be used. A nozzle may be formed of organic resin to form a liquid ejection element. The liquid ejection element may be formed before or after processing of the substrate of this embodiment. In the case of forming a liquid supply port after the substrate is processed, a supply port mask may be formed and dry etching may be performed.

In this specification, a principal application example of the present invention is mainly an inkjet recording head. However, application of the present invention is not limited thereto. Alternatively, the present invention is applicable also to liquid ejection heads for producing a biochip or electronic circuit printing. The liquid ejection head is not limited to the inkjet recording head, but may be, for instance, a color filter producing head.

The configuration of the present invention even allows a substrate having projections and depressions to be easily processed. Accordingly, a process for producing a substrate for a liquid ejection head that can reduce occurrence of warpage of the substrate to locally thin a substrate can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-013072, filed Jan. 28, 2013, which is hereby incorporated by reference herein in its entirety.

What is claimed is:

1. A process for producing a substrate for a liquid ejection head in which a depressed portion is formed on a second surface that is a surface opposite to a first surface of a silicon substrate having an element formation region on the first surface with a peripheral side region left, the process comprising the steps of:
(1) forming an etching mask layer covering the second surface of the silicon substrate;
(2) subjecting the etching mask layer and the silicon substrate to laser abrasion processing to form a pattern opening that does not pass through the silicon substrate; and
(3) performing a wet etching process to the silicon substrate where the pattern opening is formed from a side of the second surface to form the depressed portion,
wherein the depressed portion is formed over a center side region including a position corresponding to the element formation region.

2. The process for producing a substrate for a liquid ejection head according to claim 1,
wherein, in the step (2), the laser abrasion processing is performed such that the etching mask layer includes an etching mask leaving portion arranged along a periphery of the silicon substrate, and
wherein the etching mask leaving portion is not removed by the wet etching process in the step (3).

3. The process for producing a substrate for a liquid ejection head according to claim 1, wherein a plane direction of the silicon substrate is a <100> plane.

4. The process for producing a substrate for a liquid ejection head according to claim 1, wherein the etching mask layer is formed of at least one material selected from the group consisting of SiO, SiN, SiON, SiC and SiCN.

5. The process for producing a substrate for a liquid ejection head according to claim 1, wherein a laser wavelength used for the laser abrasion processing ranges from 0.532 to 0.193 μm.

6. The process for producing a substrate for a liquid ejection head according to claim 1, wherein an etchant used for the wet etching process is an aqueous solution containing at least one material selected from the group consisting of tetramethylammonium hydroxide, potassium hydroxide, sodium hydroxide, cesium hydroxide and lithium hydroxide.

7. A process for processing a silicon substrate in which a depressed portion is formed on a surface of a silicon substrate with a peripheral side region left, the process comprising the steps of:
(1) forming an etching mask layer covering the surface;
(2) subjecting the etching mask layer and the silicon substrate to laser abrasion processing to form a pattern opening that does not pass through the silicon substrate; and
(3) performing a wet etching process to the silicon substrate where the pattern opening is formed from the surface where the pattern opening is formed to form the depressed portion,
wherein the depressed portion is formed over a center side region.

8. The process for processing a silicon substrate according to claim 7,
wherein, in the step (2), the laser abrasion processing is performed such that the etching mask layer includes an etching mask leaving portion arranged along a periphery of the silicon substrate, and
wherein the etching mask leaving portion is not removed by the wet etching process in the step (3).

9. The process for processing a silicon substrate according to claim 7, wherein a plane direction of the silicon substrate is a <100> plane.

10. The process for processing a silicon substrate according to claim 7, wherein the etching mask layer is formed of at least one material selected from the group consisting of SiO, SiN, SiON, SiC and SiCN.

11. The process for processing a silicon substrate according to claim 7, wherein a laser wavelength used for the laser abrasion processing ranges from 0.532 to 0.193 μm.

12. The process for processing a silicon substrate according to claim 7, wherein an etchant used for the wet etching process is an aqueous solution containing at least one material selected from the group consisting of tetramethylammonium hydroxide, potassium hydroxide, sodium hydroxide, cesium hydroxide and lithium hydroxide.
